(19) United States
(12) Patent Application Publication
(10) Pub. No.: US 2009/0293304 A1
(43) Pub. Date: Dec. 3, 2009

(54) SENSING MULTI-STAGE CONTROL SYSTEM FOR HAND DRYERS

(75) Inventor: Che-Hua YANG, Taipei (TW)

Correspondence Address: Muncy, Geissler, Olds & Lowe, PLLC, P.O. BOX 1364, FAIRFAX, VA, 22038-1364, US

(73) Assignee: HOKWANG INDUSTRIES CO., LTD.

(21) Appl. No.: 12/129,221

(22) Filed: May 29, 2008

(51) Int. Cl. F26B 21/06; A47K 10/48

(52) U.S. Cl. 34/547; 34/554; 34/553

(57) ABSTRACT

A sensing multi-stage control system for hand dryers aims to be installed in a lavatory and energized by electric power to generate heat and airflow to dry human hands to improve shortcomings of conventional hand dryers that cannot control airflow amount and temperature level. The hand dryer according to the invention includes a heater, a fan motor and a detection unit. The detection unit has at least two sets of sensors located at an air outlet of the hand dryer and is electrically connected to a control circuit which starts, stops and controls the heater and fan motor at a desired temperature level and rotation speed to form the sensing multi-stage control system. The control circuit, incorporating with the sensors and a comparison and logic processor to process signals, can provide multi-stage control of the temperature level of the heater and rotation speed of the fan motor.

### FIELD OF THE INVENTION

The present invention relates to a wet article drying apparatus and particularly to a hand dryer control system installed in a lavatory and energized by electric power to generate heat and airflow to dry human hands.

### BACKGROUND OF THE INVENTION

People after washing hands in lavatories usually try to dry their hands with paper towels or handkerchiefs they carry with them, or the paper towels provided in public environments such as vehicle stations, office buildings, companies, plants, hotels, restaurants or malls. In many occasions, people could forget to carry the paper towels or handkerchiefs, or the paper towels are exhausted and not available in the public environments, then they have to let their hands dry naturally. The wet hands easily breed bacteria and are not hygienic. To remedy these problems, hand dryers have been developed to allow users quickly drying hands after washing in the lavatories.

In the past, the hand dryers mostly are started by pushing a touch switch to generate hot air. Such an approach requires the wet hand to push the touch switch to start the hand dryer and create a number of problems, notably:

1. Unsafe operation: as user's hands are wet before drying, they are electrically conductive and could result in electric shock.

2. Not hygienic: to start the hand dryer operation by pushing the touch switch with wet hands creates a higher possibility of virus contagion through physical contact of the touch switch.

These days, consumers have a higher demand, and technology has a greater progress; as a result, hand dryers activated by infrared sensors have been developed. Such a hand dryer usually has a fan driven by a motor and a heater, and an infrared emitter and an infrared receiver located at an air outlet of the hand dryer. When user's hands move within the detection range of the infrared emitter, an infrared signal generated by the infrared emitter is blocked, and the infrared receiver generates another signal to activate the motor to drive the fan to generate airflow, and the heater also is activated at the same time to generate heat so that the airflow passing through is heated to a higher temperature and channeled through an air outlet to be discharged to dry the user's hands.

However, such type of hand dryer that starts or stops the heater and motor through the infrared sensor delivers or stops delivering a fixed amount of airflow at a constant temperature. It still has drawbacks in practice, notably:

1. The amount and temperature level of the airflow cannot be controlled: the site where the hand dryer is installed varies and users' requirements could be different, especially in terms of airflow amount and temperature level. For instance, climate conditions could change greatly in winter and summer, and temperature level requirements could alter significantly. The hand dryer that cannot control airflow amount and temperature level cannot fully meet user's requirements.

2. As the conventional hand dryer does not provide control function of the airflow amount and temperature level, ancillary function such as indicating the airflow amount and temperature reading also is not available.

### SUMMARY OF THE INVENTION

The primary object of the present invention is to provide two or more non-touch sensing sensors incorporating with a comparison and logic processor to process signals to enable a control circuit to provide multi-stage control of a heater to reach a selected temperature and a fan motor to rotate at a desired speed, so that the amount of airflow and temperature thereof of a hand dryer can be easily and quickly controlled by users to meet safety and hygienic requirements.

To achieve the foregoing object, the present invention provides a sensing multi-stage control system for hand dryers. The hand dryer according to the invention includes:

a heater close to an air outlet of the hand dryer to raise the temperature of airflow;

a fan motor located in the hand dryer to generate and deliver the airflow; and

a sensing multi-stage control system located at the air outlet that has a detection unit and a control circuit. The detection unit has at least two sets of sensors electrically connected to the control circuit. The control circuit starts and stops the heater and fan motor; and controls the temperature of the heater at a selected level and the rotation speed of the fan motor.

By means of the technique of the invention, the invention provides many benefits over the conventional techniques, notably:

1. The invention provides functions of controlling airflow amount and temperature level of the hand dryer, thus can better meet user's requirements regardless the installation environment. It especially adaptable to suit climate change in winter and summer in which user's requirement of temperature level differs significantly. By providing the functions of controlling airflow amount and temperature level, the practicality improves.

2. The invention provides a fast and simple control means: alteration of airflow amount and temperature level can be controlled by placing a targeted object (user's hands) within the detection range of the hand dryer. Thus it can be done quickly and easily by the users after finishing hand washing by simply extending the wet hands in a selected direction.

3. Safer operation and control: Although the targeted object (user's hands) is wet before drying and is electrical conductive that might incur electric shock, the invention provides a non-touch sensing means to start and stop control of alteration of the airflow amount and temperature level, thus is much safer.

4. The control method of the invention can better meet the hygienic requirement of modern people: Due to the sensors are non-touch sensing types, user's hands are not in contact with the control panel. Hence virus contagion that might otherwise occur due to direct contact can be avoided.

5. An ancillary function of indicating the airflow amount and temperature level can be added in the invention: The invention may include a signal converter, a display device and a loudspeaker, thus can convert a control signal to a video signal to be displayed on the display device, or be transformed to an audio signal to be broadcast through the loudspeaker so that users can be instantly informed regarding the temperature and airflow amount of the hand dryer.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of an embodiment of the sensing multi-stage control system for hand dryers of the invention.

FIG. 2A is a schematic view of a detection unit of the invention in a first condition.

FIG. 2B is a control status table of the detection unit of the invention in the first condition.

FIG. 3A is a schematic view of the detection unit of the invention in a second condition.

FIG. 3B is a control status table of the detection unit of the invention in the second condition.

FIG. 4A is a schematic view of the detection unit of the invention in a third condition.

FIG. 4B is a control status table of the detection unit of the invention in the third condition.

FIG. 5 is a block diagram of another embodiment of the sensing multi-stage control system for hand dryers of the invention.

### DETAILED DESCRIPTION OF THE PREFERRED EMBODIMENTS

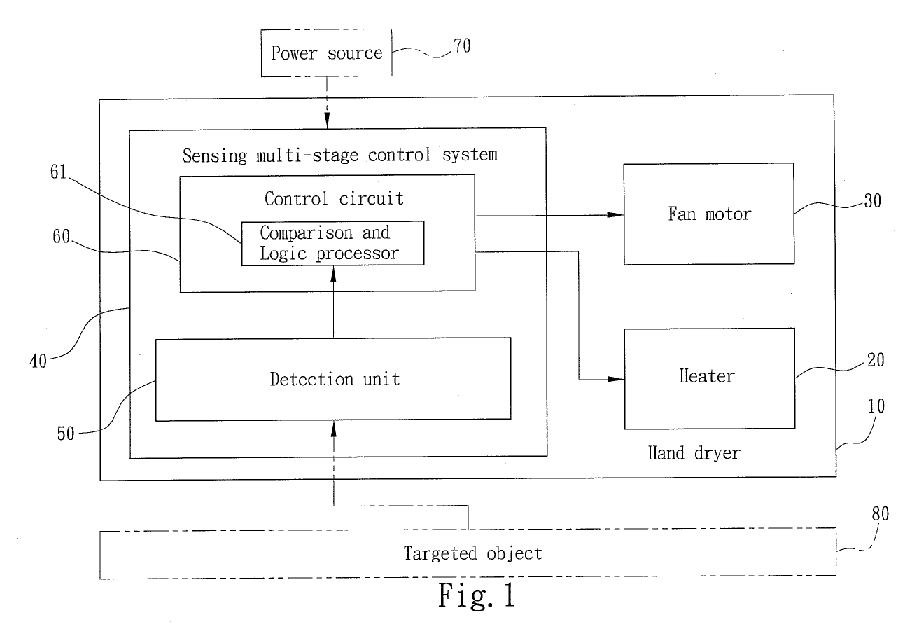

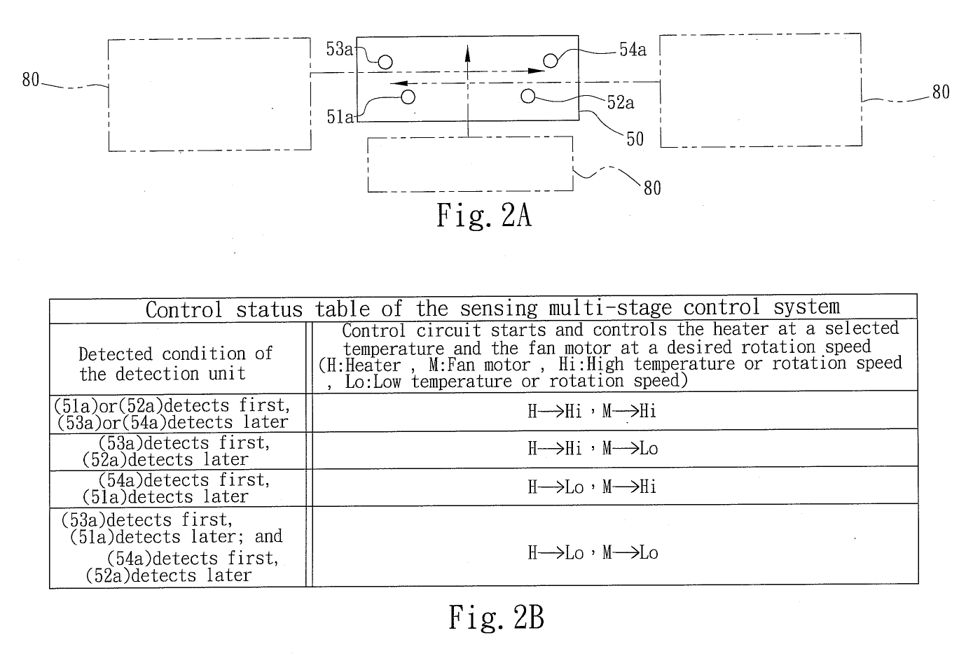

Please refer to FIGS. 1 and 2A for a block diagram of a first embodiment of the sensing multi-stage control system for hand dryers of the invention, and a first condition of the detection unit. The hand dryer 10 according to the invention includes a heater 20 located inside close to an air outlet thereof (it is known in the art, thus is not shown in the drawings), a fan motor 30 located inside to generate and deliver airflow and a detection unit 50 electrically connected to a control circuit 60 to start and stop the heater 20 and the fan motor 30. This embodiment provides features as follows: the detection unit 50 is located at the air outlet of the hand dryer 10, and includes four sets of sensors 51a, 52a, 53a and 54a. These sensors are electrically connected to the control circuit 60 which starts and stops the heater 20 and fan motor 30 and controls the temperature level and rotation speed thereof to form a sensing multi-stage control system 40. The sensing multi-stage control system 40 receives electric power from a power source 70. Each of the sensors 51a, 52a, 53a and 54a has an emission end and a receiving end (not shown in the drawings). These four sensors 51a, 52a, 53a and 54a may be infrared sensors or CCDs (Charge Coupled Devices). In addition, the control circuit 60 has a comparison and logic processor 61 electrically connected to the detection unit 50. The comparison and logic processor 61 has a comparator (not shown in the drawings) to compare detection sequence of the sensors 51a, 52a, 53a and 54a, and a logic processor (also not shown in the drawings) to perform logical judgment. Refer to FIG. 2B for a control status table of the detection unit in the first condition. As there are four sensors 51a, 52a, 53a and 54a in the detection unit 50 (referring to FIG. 2A), when a targeted object 80 moves from the front side into a detection range of the detection unit 50, the comparison and logic processor 61 senses that one of the sensors 51a and 52a detects first; next, one of other sensors 53a and 54a also detects; then a signal process is executed. And the control circuit 60 starts the heater 20 and fan motor 30, and alters the temperature of the heater 20 and rotation speed of the fan motor 30 to a preset condition (H→Hi, M→Hi). When the targeted object 80 moves away from the detection range of the detection unit 50, the control circuit 60 stops operation of the heater 20 and fan motor 30. When the targeted object 80 moves from the left side towards the right side into the detection range of the detection unit 50, the comparison and logic processor 61 senses that the sensor 53a detects first; next, another sensor 52a detects; then the signal process is executed. And the control circuit 60 starts the heater 20 and fan motor 30, and alters the temperature of the heater 20 and rotation speed of the fan motor 30 to another preset condition (H→Hi, M→Lo). Similarly, when the targeted object 80 moves away from the detection range of the detection unit 50, the control circuit 60 stops operation of the heater 20 and fan motor 30. By the same token, when the targeted object 80 moves from the right side towards the left side into the detection range of the detection unit 50, the comparison and logic processor 61 senses that the sensor 54a detects first; next, another sensor 51a detects; then the signal process is executed. And the control circuit 60 starts the heater 20 and fan motor 30, and alters the temperature of the heater 20 and rotation speed of the fan motor 30 to yet another preset condition (H→Lo, M→Hi). Finally, when the targeted object 80 moves away from the detection range of the detection unit 50, the control circuit 60 stops operation of the heater 20 and fan motor 30. In the event that one targeted object 80 moves from the left side towards the right side into the detection range of the detection unit 50, and another targeted object 80 moves almost at the same time from the right side towards the left side into the detection range of the detection unit 50, the comparison and logic processor 61 senses that the sensor 53a detects first; next, another sensor 51a detects, and the sensor 54a also detects first; and the other sensor 52a detects later; then the signal process is executed, and the control circuit 60 starts the heater 20 and fan motor 30, and alters the temperature of the heater 20 and rotation speed of the fan motor 30 to yet another preset condition (H→Lo, M→Lo). The comparison and logic processor 61 compares and judges various different detection conditions of the detection unit 50 to adjust the temperature of the heater 20 and rotation speed of the fan motor 30 according to preset conditions in response to varying requirements.

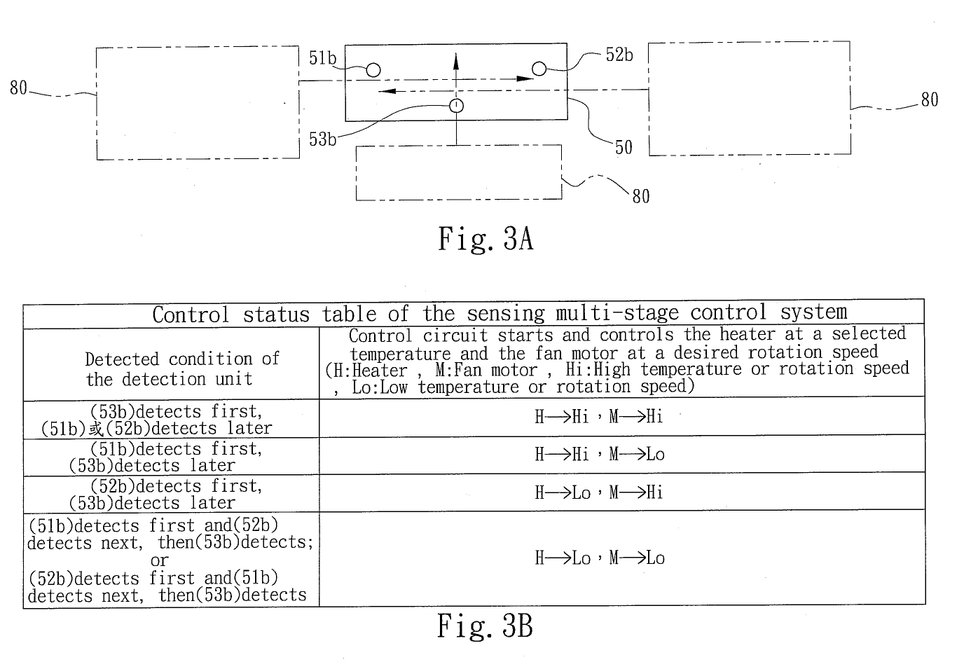

Refer to FIGS. 3A and 3B for the detection unit in a second condition and the sensing multi-stage control system in such a condition. In FIG. 3A, the detection unit 50 has three sets of sensors 51b, 52b and 53b which have respectively an emission end and a receiving end (not shown in the drawings). These three sensors 51b, 52b and 53b may be infrared sensors or CCDs. When the targeted object 80 moves from the front side into the detection range of the detection unit 50, the comparison and logic processor 61 senses that the sensor 53b detects first; then one of other sensors 51b and 52b detects; then a signal process is executed. And the control circuit 60 starts the heater 20 and fan motor 30, and alters the temperature of the heater 20 and rotation speed of the fan motor 30 to a preset condition (H→Hi, M→Hi). When the targeted object 80 moves away from the detection range of the detection unit 50, the control circuit 60 stops operation of the heater 20 and fan motor 30. When the targeted object 80 moves from the left side towards the right side into the detection range of the detection unit 50, the comparison and logic processor 61 senses that the sensor 51b detects first; next, another sensor 53b detects; then the signal process is executed. And the control circuit 60 starts the heater 20 and fan motor 30, and alters the temperature of the heater 20 and rotation speed of the fan motor 30 to another preset condition (H→Hi, M→Lo). Similarly, when the targeted object 80 moves away from the detection range of the detection unit 50, the control circuit 60 stops operation of the heater 20 and fan motor 30. When the targeted object 80 moves from the right side towards the left side into the detection range of the detection unit 50, the comparison and logic processor 61 senses that the sensor 52b detects first; next, another sensor 53b detects; then the signal process is executed. And the control circuit 60 starts the heater 20 and fan motor 30, and alters the temperature of the heater 20 and rotation speed of the fan motor 30 to yet another preset condition (H→Lo, M→Hi). Finally, when the targeted object 80 moves away from the detection range of the detection unit 50, the control circuit 60 stops operation of the heater 20 and fan motor 30. In the event that one targeted object 80 moves from the left side towards the right side into the detection range of the detection unit 50, and another targeted object 80 moves almost at the same time from the right side towards the left side into the detection range of the detection unit 50, the comparison and logic processor 61 senses that the sensor 51b detects first; next, another sensor 52b detects, and finally yet another sensor 53b detects; then the signal process is executed. Or the sensor 52b detects first; next, another sensor 51b detects, and finally yet another sensor 53b detects; then the signal process is executed. And the control circuit 60 starts the heater 20 and fan motor 30, and alters the temperature of the heater 20 and rotation speed of the fan motor 30 to another preset condition (H→Lo, M→Lo). Similarly, the comparison and logic processor 61 compares and judges various different detection conditions of the detection unit 50 to adjust the temperature of the heater 20 and rotation speed of the fan motor 30 according to preset conditions in response to varying requirements.

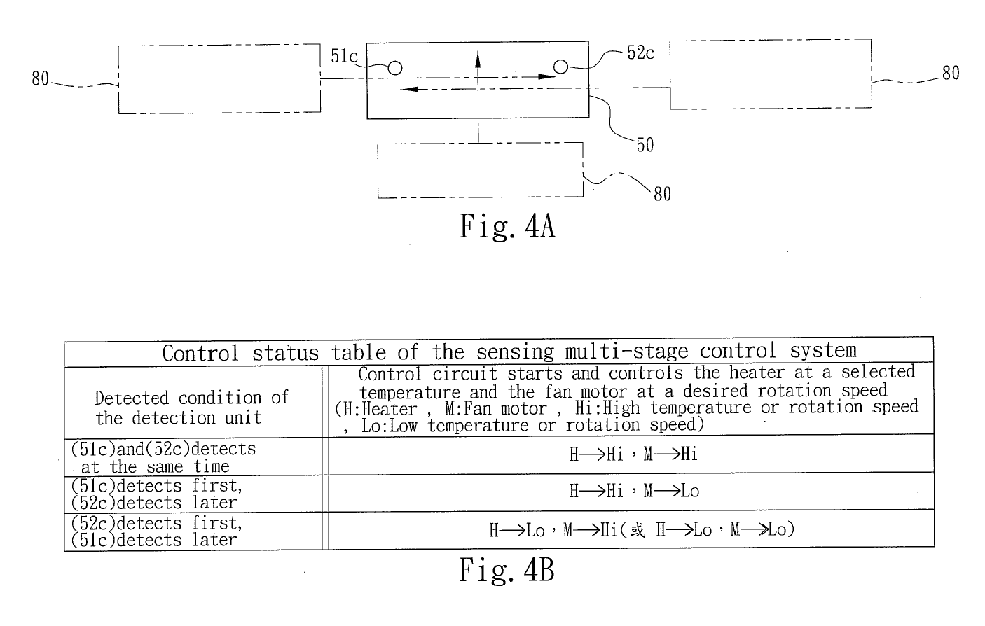

Refer to FIGS. 4A and 4B for the detection unit in a third condition and the sensing multi-stage control system in such a condition. In FIG. 4A, the detection unit 50 has two sets of sensors 51c and 52c which have respectively an emission end and a receiving end (not shown in the drawings). These two sensors 51c and 52c may be infrared sensors or CCDs. When the targeted object 80 moves from the front side into the detection range of the detection unit 50, the comparison and logic processor 61 senses that the sensors 51c and 52c detect almost at the same time, then a signal process is executed. And the control circuit 60 starts the heater 20 and fan motor 30, and alters the temperature of the heater 20 and rotation speed of the fan motor 30 to a preset condition (H→Hi, M→Hi). When the targeted object 80 moves away from the detection range of the detection unit 50, the control circuit 60 stops operation of the heater 20 and fan motor 30. When the targeted object 80 moves from the left side towards the right side into the detection range of the detection unit 50, the comparison and logic processor 61 senses that the sensor 51c detects first; next, another sensor 52c detects; then the signal process is executed. And the control circuit 60 starts the heater 20 and fan motor 30, and alters the temperature of the heater 20 and rotation speed of the fan motor 30 to another preset condition (H→Hi, M→Lo). When the targeted object 80 moves away from the detection range of the detection unit 50, the control circuit 60 stops operation of the heater 20 and fan motor 30. Finally, when the targeted object 80 moves from the right side towards the left side into the detection range of the detection unit 50, the comparison and logic processor 61 senses that the sensor 52c detects first; next, another sensor 51c detects; then the signal process is executed. And the control circuit 60 starts the heater 20 and fan motor 30, and alters the temperature of the heater 20 and rotation speed of the fan motor 30 to yet another preset condition (H→Lo, M→Hi, or H→Lo, M→Lo). Similarly, the comparison and logic processor 61 compares and judges various different detection conditions of the detection unit 50 to adjust the temperature of the heater 20 and rotation speed of the fan motor 30 according to preset conditions in response to varying requirements.

Based on the various conditions previously discussed, in FIG. 1 the detection unit 50 has two or more sensors (not shown in the drawing), by incorporating with signal process of the comparison and logic processor 61, the control circuit 60 can control the temperature of the heater 20 and rotation speed of the fan motor 30 in a multi-stage fashion.

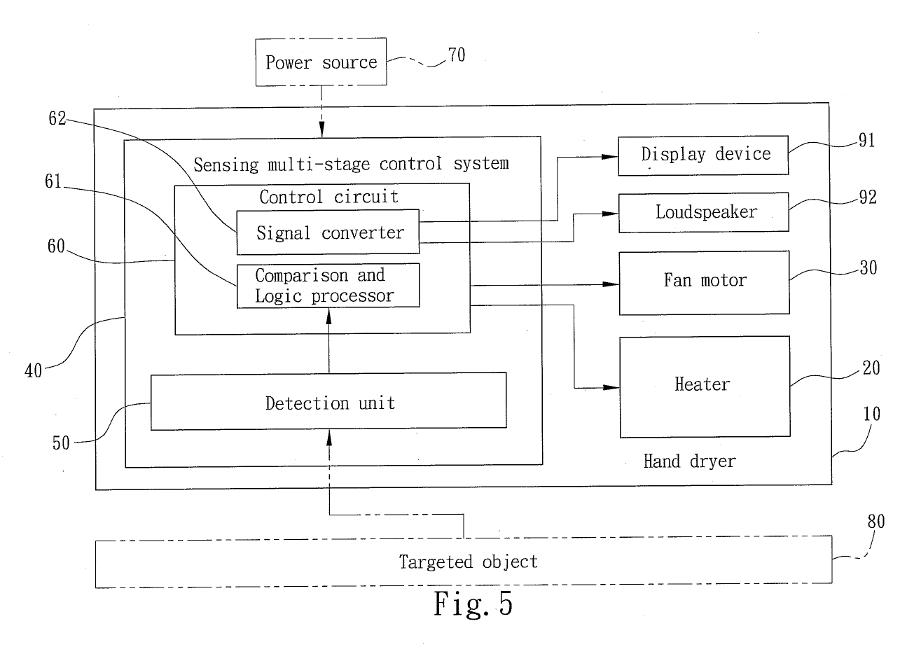

Refer to FIG. 5 for another embodiment of the sensing multi-stage control system for hand dryers of the invention. In this embodiment, the hand dryer 10 includes the heater 20 located inside close to the air outlet thereof (it is known in the art, thus is not shown in the drawings), the fan motor 30 located inside to generate and deliver airflow and the detection unit 50 electrically connected to the control circuit 60 to start and stop the heater 20 and the fan motor 30. This embodiment provides features as follows: the detection unit 50 includes at least two sets of sensors (not shown in the drawing) located at the air outlet and is electrically connected to the control circuit 60 which starts and stops the heater 20 and fan motor 30 and controls the temperature level and rotation speed thereof to form the sensing multi-stage control system 40. The sensing multi-stage control system 40 receives electric power from a power source 70. The control circuit 60 has the comparison and logic processor 61 electrically connected to the detection unit 50. The control circuit 60 also has a signal converter 62, and the hand dryer 10 has a display device 91 and a loudspeaker 92. The signal converter 62 aims to transform signals of preset conditions corresponding to the temperature of the heater 20 and rotation speed of the fan motor 30 in response to various detection conditions of the detection unit 50 to video signals to be displayed on the display device 91, or audio signals to be broadcast through the loudspeaker 92. Thereby users can be instantly informed of the temperature of the hand dryer 10 and airflow amount of the fan motor 30.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A sensing multi-stage control system for a hand dryer, the hand dryer comprising:
a heater located in the hand dryer close to an air outlet of the hand dryer to heat airflow to a selected temperature;
a fan motor located inside to generate and deliver the airflow from the inside of the hand dryer; and
a sensing multi-stage control system which is located at the air outlet and has a detection unit and a control circuit, the detection unit having at least two sets of sensors electrically connected to the control circuit, the control circuit starting and stopping the heater and the fan motor, and controlling temperature of the heater and rotation speed of the fan motor.

2. The sensing multi-stage control system for a hand dryer of claim 1, wherein the control circuit has a comparison and logic processor electrically connected to the detection unit.

3. The sensing multi-stage control system for a hand dryer of claim 2, wherein the comparison and logic processor has a comparator to compare detection sequence of the sensors and a logic processor to perform logical judgment of the detection sequence.

4. The sensing multi-stage control system for a hand dryer of claim 3, wherein the control circuit has a signal converter.

5. The sensing multi-stage control system for a hand dryer of claim 4, wherein the hand dryer has a display device to output signals of the signal converter.

6. The sensing multi-stage control system for a hand dryer of claim 4, wherein the hand dryer has a loudspeaker to output signals of the signal converter.

7. The sensing multi-stage control system for a hand dryer of claim 1, wherein each of the sensors has an emission end and a receiving end.

8. The sensing multi-stage control system for a hand dryer of claim 7, wherein the sensors are infrared sensors.

9. The sensing multi-stage control system for a hand dryer of claim 7, wherein the sensors are Charge Coupled Devices.

10. The sensing multi-stage control system for a hand dryer of claim 7, wherein the control circuit has a comparison and logic processor electrically connected to the detection unit.

11. The sensing multi-stage control system for a hand dryer of claim 10, wherein the comparison and logic processor has a comparator to compare detection sequence of the sensors and a logic processor to perform logical judgment of the detection sequence.

12. The sensing multi-stage control system for a hand dryer of claim 11, wherein the control circuit has a signal converter.

13. The sensing multi-stage control system for a hand dryer of claim 12, wherein the hand dryer has a display device to output signals of the signal converter.

14. The sensing multi-stage control system for a hand dryer of claim 12, wherein the hand dryer has a loudspeaker to output signals of the signal converter.
